(19) United States
(12) Patent Application Publication
(10) Pub. No.: US 2005/0186852 A1
(43) Pub. Date: Aug. 25, 2005

(54) Connector module

(75) Inventors: Han-Cheng Hsu, Taoyuan Hsien (TW); Chih-Tse Chen, Taoyuan Hsien (TW); Ching-Man Kao, Taoyuan Hsien (TW)

Correspondence Address: BIRCH STEWART KOLASCH & BIRCH, PO BOX 747, FALLS CHURCH, VA, 22040-0747, US

(73) Assignee: Delta Electronics, Inc.

(21) Appl. No.: 11/062,433

(22) Filed: Feb. 23, 2005

(30) Foreign Application Priority Data
Feb. 24, 2004 (TW) 93104661

(51) Int. Cl. H01R 24/00

(52) U.S. Cl. 439/676

(57) ABSTRACT

A connector module is described. The connector module efficiently reduces an occupation area of a connector and control circuits thereof on a circuit board and provides various circuit board connecting interfaces packaged by various package processes. The connector module has a shell, a connector, a control integrated circuit, and a circuit board connecting interface. The connector and the control integrated circuit are configured in the shell. The control integrated circuit controls signal transmissions for the connector module. The connector module further has a transformer configured in the shell.

### RELATED APPLICATIONS

The present application is based on, and claims priority from, Taiwan Application Serial Number 93104661, filed on Feb. 24, 2004, the disclosure of which is hereby incorporated by reference herein in its entirety.

### FIELD OF THE INVENTION

The present invention relates to a connector module, and more particularly, to a connector module with a transformer and an integrated circuit therein.

### BACKGROUND OF THE INVENTION

Due to highly developed information technology, electrical and information products are more popular and convenient for users. Computer systems and peripherals thereof progress greatly, day by day, and people can search for information and provide services with networks. Via networks, people enjoy a comfortable and fast information search environment.

The wide proliferation of personal computers and networks allows people to utilize networks to search for and provide information. Currently, only a small quantity of computers and concentrated computers cannot provide enough information and data for business utilization. In a normal company, the computer system are distributed and connected by the network to provide enough service and information for business requirements. Hence, a personal computer, a notebook computer, or even a handheld computer provides an interface to connect with the network.

The computer apparatuses connected to the networks are usually connected to the network directly or through a related electronic device such as, for example, a hub, with connectors. Conventional and popular connectors for connecting to the network are a pair of RJ-45 connectors, for example an RJ-45 jack and an RJ-45 plug. When the relative electrical device receives the signals from the RJ-45 connector, the signals are transmitted by way of a circuit board connected with the RJ-45 connector to a transformer and an integrated circuit for processing, receiving and transmitting these signals.

Therefore, a conventional circuit board of the electrical device with the RJ-45 connector has to layout positions for RJ-45 connectors, transformers, and control integrated circuits to fix them on the circuit board. Hence, the connectors, transformers, and control integrated circuits have to occupy a predetermined area on the circuit board and become a bottleneck for reductions in the appearance dimensions of the electrical device.

### SUMMARY OF THE INVENTION

It is an objective of the present invention to provide a connector module to integrate a control integrated circuit, connectors, and transformers so as to reduce the appearance dimension of the electrical equipment with the connector module.

It is another objective of the present invention to provide an RJ-45 connector module to integrate a control integrated circuit, a connector, and a transformer into the module shell and utilize the pins of the control integrated circuit to couple to a circuit board so as to reduce an occupation area thereof on the circuit board.

To accomplish the above objectives, the present invention provides a connector module to save effectively an occupation area on a circuit board and that applies to various packaging processes to form various circuit board connecting interfaces. The connector module has a shell, a connector, a control integrated circuit and a circuit board connecting interface. The connector and the control integrated circuit are configured in the shell of the connector module. The connector is utilized to connect with a network, and the control integrated circuit controls and transmits signals for the connector module. The circuit board connecting interface is utilized to couple to a circuit board to transmit the signals therebetween. The connector is an RJ-45 connector, an RJ-11 connector, or the like.

The connector module further has a transformer configured in the shell and coupled between the connector and the control integrated circuit to increase an insulation voltage between the connector module and the network.

The circuit board connecting interface is a ball grid array (BGA) input/output interface, L-type pins packaged by a small outline package (SOP), or J-type pins packaged by a plastic leaded chip carrier (PLCC). The circuit board connecting interface can also be pins for a through hole device.

The connector module further has a positioner and a fixing member coupling to a bottom surface of the shell to couple accurately the connector module to the circuit board and to enhance a conjunction strength therebetween.

The connector module more preferably applies to RJ-45 connector to couple an electrical device to the network. Because the control IC and the transformer are integrated in the shell of the connector module, the connector module according to the present invention can utilize the pins of the control IC to couple to the circuit board so that the occupation area on the circuit board can therefore be effectively reduced. Accordingly, the appearance dimensions of the electrical equipment with the connector module can be therefore shrunk.

### BRIEF DESCRIPTION OF THE DRAWINGS

The foregoing aspects and many of the attendant advantages of this invention are more readily appreciated as the same becomes better understood by reference to the following detailed description, when taken in conjunction with the accompanying drawings, wherein:

FIG. 1 is a block diagram of a connector module according to the present invention;

FIG. 2 is a schematic view of a first preferred embodiment of the connector module according to the present invention;

FIG. 3 is a schematic view of a second preferred embodiment of the connector module according to the present invention;

FIG. 4 is a schematic view of a third preferred embodiment of the connector module according to the present invention; and

FIG. 5 is a schematic view of a fourth preferred embodiment of the connector module according to the present invention.

### DETAILED DESCRIPTION OF THE PREFERRED EMBODIMENT

The following description is of the best presently contemplated mode of carrying out the present invention. This description is not to be taken in a limiting sense but is made merely for the purpose of describing the general principles of the invention. The scope of the invention should be determined by referencing the appended claims.

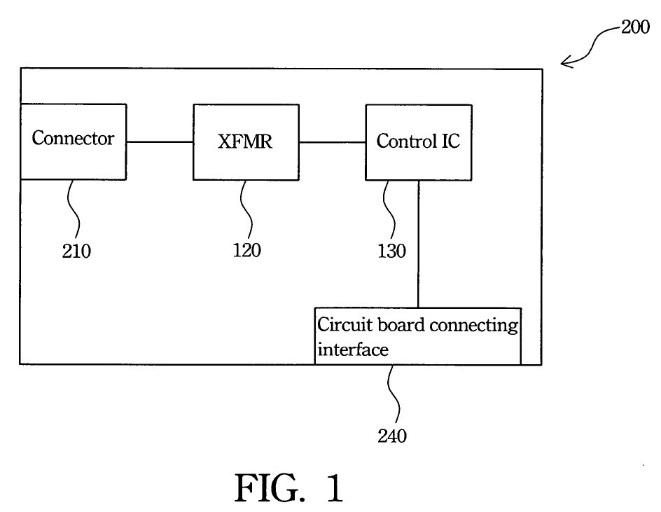

FIG. 1 is a block diagram of a connector module according to the present invention. The connector module 200 has a connector 210, a transformer 120, an integrated circuit (IC) 130, and a circuit board connecting interface 240. The connector 210 is coupled to a corresponding connector for transmitting signals. The transformer 120 transmits the signals, increases an insulation voltage between the network and the connector module 200, and further reduces an error rate of the transmitting signals. The control IC 130 provides functions to control and connect the connector module 200 to the network.

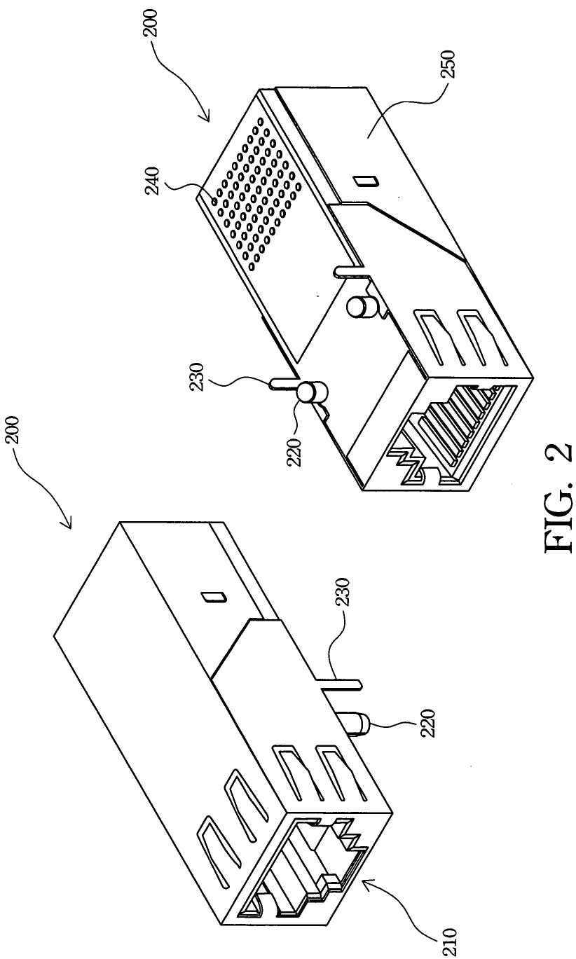

FIG. 2 is a schematic view of a first preferred embodiment of the connector module according to the present invention. The first preferred embodiment is illustrated with an RJ-45 connector module. The RJ-45 connector module 200 utilizes an RJ-45 connector 210 to couple to the network. The RJ-45 connector module 200 belongs to a surface mount device (SMD). A bottom surface of a shell 250 of the RJ-45 connector module 200 includes welding pads 240 for coupling to solder balls to join with a circuit board. It is preferably, for example, a ball grid array (BGA) to enhance the input/output interface density.

Inside of the shell 250, the RJ-45 connector module 200 has the transformer and the control IC to provide functions for transmitting network signals. The welding pads 240 can directly connect with an input/output interface of the control IC or through an exchange interface to connect with the input/output interface of the control IC.

The bottom surface of the shell 250 further has positioners 220 and fixing members 230. The positioners 220 efficiently enhance the accuracy between the RJ-45 connector module 200 and the circuit board for fixing the RJ-45 connector module 200. The fixing members 230 enhance the conjunction strength therebetween.

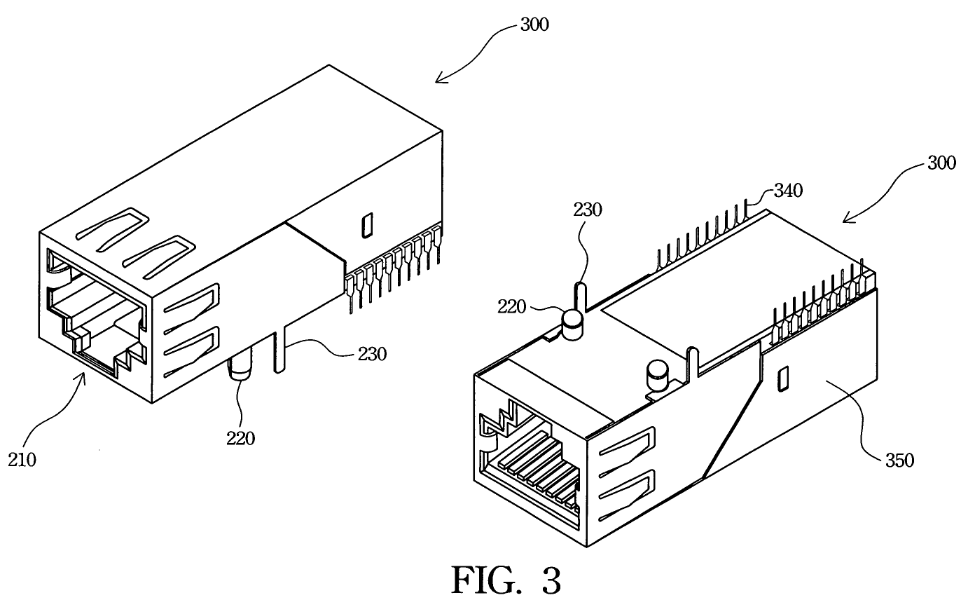

FIG. 3 is a schematic view of a second preferred embodiment of the connector module according to the present invention. The second preferred embodiment illustrates an RJ-45 connector module 300, which belongs to a through hole device (THD). The bottom surface of a shell 350 of the RJ-45 connector module 300 has pins 340, e.g. a dual in-line package (DIP)-type, for connecting with a circuit board to transmit signals between the RJ-45 connector module 300 and the circuit board.

The bottom surface of the shell 350 further has positioners 320 and fixing members 330. The positioners 320 can also enhance the accuracy between the RJ-45 connector module 300 and the circuit board for fixing the RJ-45 connector module 300. The fixing members 330 further enhance the conjunction strength therebetween.

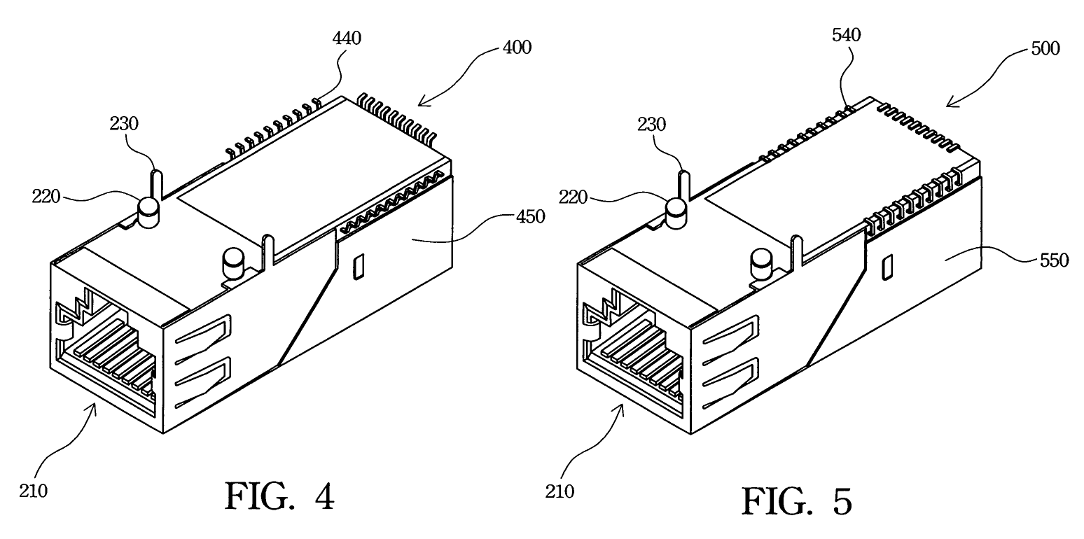

FIG. 4 and FIG. 5 are schematic views of a third and a fourth preferred embodiments of the connector module according to the present invention, respectively. FIG. 4 illustrates an RJ-45 connector module 400 with L-type pins 440 on a bottom surface of a shell 450 and FIG. 5 illustrates an RJ-45 connector module 500 with J-type pins 540 on a bottom surface of a shell 550. It is appreciated that the foregoing preferred embodiments illustrate various connecting interfaces for the connector module to couple to the circuit board. It will be readily apparent to those skilled in the art that this invention is not limited to the embodiments described above. Different configurations and embodiments can be developed without departing from the scope of the invention and are intended to be included within the scope of the invention.

The connecting interface of the connector module for coupling to the circuit board can utilize various types of packaging process for application to different circuit board designs. The RJ-45 connector modules 400 and 500 both belong to the surface mount device. The RJ-45 connector module 400 is packaged by, for example, a small outline package (SOP), and the RJ-45 connector module 500 is packaged in, for example, a plastic leaded chip carrier (PLCC). Although the preferred embodiment is illustrated with an RJ-45 connector, the connector module is not limited to the RJ-45 connector, and the connector module can also apply to RJ-11 connectors, RJ-12 connectors or the like.

The connector module according to the present invention can integrate the transformer and the control IC configured in the shell of the connector module, and further utilize the connecting pins of the control IC to couple to the circuit board. Therefore, the connector module according to the present invention can reduce the occupation area on the circuit board. Accordingly, the electrical equipment with the connector module according to the present invention can therefore be shrunk. The connector module according to the present invention can be a surface mount device or a through hole device, and the connector module can therefore apply to various circuit board designs to transmit signals in a reduced dimensions.

As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

1. A connector module, comprising:
a shell;
a connector configured in the shell to couple to a network;
a transformer configured in the shell and coupled to the connector to increase an insulation voltage between the connector module and the network;
a control integrated circuit configured in the shell and coupled to the transformer to control and transmit network signals;
a circuit board connecting interface coupling to the control integrated circuit and a circuit board to transmit the network signals;
a positioner coupling to a bottom surface of the shell to couple accurately the connector module to the circuit board; and
a fixing member coupling to the bottom surface of the shell to enhance a conjunction strength between the connector module and the circuit board.

2. The connector module of claim 1, wherein the circuit board connecting interface comprises a ball grid array (BGA) input/output interface.

3. The connector module of claim 1, wherein the circuit board connecting interface comprises L-type pins packaged by a small outline package (SOP).

4. The connector module of claim 1, wherein the circuit board connecting interface comprises J-type pins packaged by a plastic leaded chip carrier (PLCC).

5. The connector module of claim 1, wherein the connector is an RJ-45 connector or an RJ-11 connector.

6. A connector module, comprising:
a shell;
a connector configured in the shell to couple to a network;
a transformer configured in the shell and coupled to the connector to increase an insulation voltage between the connector module and the network;
a control integrated circuit configured in the shell and coupled to the transformer to control and transmit network signals; and
a circuit board connecting interface coupling to the control integrated circuit and a circuit board to transmit the network signals.

7. The connector module of claim 6, wherein the circuit board connecting interface comprises a ball grid array (BGA) input/output interface.

8. The connector module of claim 6, wherein the circuit board connecting interface comprises L-type pins packaged by a small outline package (SOP).

9. The connector module of claim 6, wherein the circuit board connecting interface comprises J-type pins packaged by a plastic leaded chip carrier (PLCC).

10. The connector module of claim 6, wherein the circuit board connecting interface comprises pins.

11. The connector module of claim 6, wherein the connector module further comprises a positioner coupling to a bottom surface of the shell accurately to couple the connector module to the circuit board.

12. The connector module of claim 6, wherein the connector module further comprises a fixing member coupling to a bottom surface of the shell to enhance a conjunction strength between the connector module and the circuit board.

13. The connector module of claim 6, wherein the connector is an RJ-45 connector or an RJ-11 connector.

14. A connector module, comprising:
a shell;
a connector configured in the shell;
a control integrated circuit configured in the shell and coupled to the connector to control and transmit signals of the connector module; and
a circuit board connecting interface coupling to the control integrated circuit and a circuit board to transmit the signals.

15. The connector module of claim 14, wherein the connector is an RJ45 connector or an RJ-11 connector.

16. The connector module of claim 14, wherein the connector module further comprises a transformer configured in the shell and coupled between the connector and the control integrated circuit to increase an insulation voltage between the connector module and a network.

17. The connector module of claim 14, wherein the circuit board connecting interface is a ball grid array (BGA) input/output interface, L-type pins packaged by a small outline package (SOP), or J-type pins packaged by a plastic leaded chip carrier (PLCC).

18. The connector module of claim 14, wherein the circuit board connecting interface comprises pins.

19. The connector module of claim 14, wherein the connector module further comprises a positioner coupling to a bottom surface of the shell accurately to couple the connector module to the circuit board.

20. The connector module of claim 14, wherein the connector module further comprises a fixing member coupling to a bottom surface of the shell to enhance a conjunction strength between the connector module and the circuit board.
